(19) United States
(12) Patent Application Publication
(10) Pub. No.: US 2017/0316433 A1
(43) Pub. Date: Nov. 2, 2017

(54) IDENTITY AGGREGATION AND INTEGRATION

(71) Applicant: NCR Corporation, Duluth, GA (US)

(72) Inventors: Nagendra Kumar Revanur, San Jose, CA (US); Yehoshua Zvi Licht, Alphareta, GA (US); David Todd Slaughter, Cumming, GA (US)

(21) Appl. No.: 15/142,122

(22) Filed: Apr. 29, 2016

(51) Int. Cl. G06Q 30/02; G06Q 20/40; G06F 17/30

(52) U.S. Cl. CPC G06Q 30/0201; G06F 17/30528; G06Q 20/405

(57) ABSTRACT

A global identity for a user is established and aggregated or federated for various personas of the user across transaction data for multiple lines-of business (LOB). Integration services provide features for integrating cross-LOB transactions, reporting, transacting, and/or metrics generation based on the global identity.

### BACKGROUND

Nearly everything about a consumer is being captured daily and private information about the consumer is stored on a variety of online-accessible services. In fact, almost every aspect of a consumer's activity and habits is being captured in electronic format somewhere at any given point in time.

Today, consumers engage in transactions across multiple different lines of business. These transactions are recorded separately, the systems that record them have little to no knowledge of each other or, even, the consumer.

For example, a consumer decides to go to a football game. The consumer purchases his/her ticket online and requests the ticket be sent to his/her mobile device. The ticket is generated and sent as a barcode accessible from the mobile device. While at the game, the consumer also purchases a jersey for his favorite player and buys some alcohol and various snacks. Typically, these transactions would be separate events appearing in systems for separate lines of businesses (e.g., entertainment, apparel, food, etc.) with no discernable relationship to one another and no real-time availability for making recommendations to the consumer or presenting offers that he/she may be interested in knowing about. However, each of these may have a customer identifier that is unique to a particular line of business but unrecognized across a different line of business.

Presently, there is no mechanism to authenticate a consumer across multiple lines of business. Also, there is no support for dynamically discovering the implicit/single consumer identifier embedded in all the transactions (across multiple lines of business) along with any explicit consumer approval or authorization to enable such discovery.

Essentially, there is no mechanism available for identifying a consumer and that consumer's preferences for cross-line of business activities.

### SUMMARY

In various embodiments, methods and a system for identity aggregation and integration are presented.

According to an embodiment, a method for identity aggregation and integration is provided. Specifically, in an embodiment, transactional data for a persona of a user from a line of business (LOB) is aggregated with second transactional data for a second persona of the user from a second LOB. Next, integration services are provided for the transaction data and the second transaction data.

### BRIEF DESCRIPTION OF THE DRAWINGS

FIG. 1A is a diagram of a system for identity aggregation and integration, according to an example embodiment.

FIG. 1B is a diagram a sample architecture for practicing identity aggregation and integration according to an example embodiment.

FIG. 2 is a diagram of a method for identity aggregation and integration, according to an example embodiment.

FIG. 3 is a diagram of another method for identity aggregation and integration, according to an example embodiment.

FIG. 4 is a diagram of a system for identity aggregation and integration, according to an example embodiment.

### DETAILED DESCRIPTION

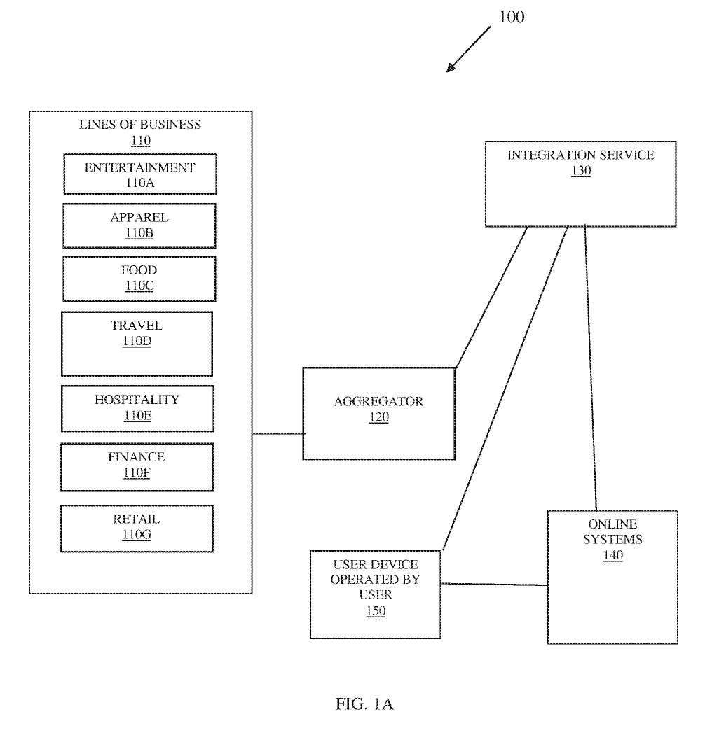

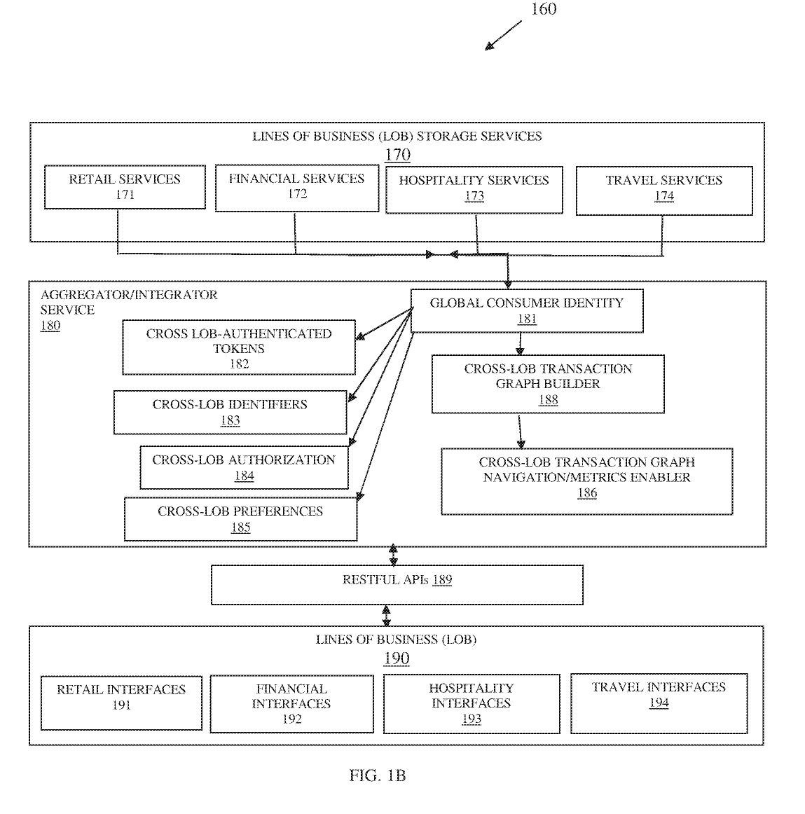

FIG. 1A is a diagram of a system for identity aggregation and integration, according to an example embodiment. The system 100 is shown schematically in greatly simplified form, with only those components relevant to understanding of one or more embodiments (represented herein) being illustrated. The various components are illustrated and the arrangement of the components is presented for purposes of illustration only. It is to be noted that other arrangements with more or less components are possible without departing from the identity aggregation and integration processing presented herein and below.

Moreover, various components are illustrated as one or more software modules, which residing in non-transitory storage and/or hardware memory as executable instructions that when executed by one or more hardware processors perform the processing discussed herein and below.

The techniques, methods, and systems presented herein and below for identity aggregation and integration can be implemented in all, or some combination of the components shown in different hardware computing devices having one or more hardware processors.

The system 100 includes various lines of business (LOB) data repositories 110, an aggregator 120, an integration service 130, a variety of online systems 140 (or online services accessible electronically over a network (wired, wirelessly, or a combination of wired and wireless)), and at least one user device operated by a user (or a customer of one of the online systems 140).

The LOB repositories 110 maintain transaction data for consumers within these different LOB repositories 110. The transaction data can include such things as: purchases, entertainment ticket redemption, gaming, social media, and the like. Again, a consumer's activity can be captured in one of these LOB repositories 110 based on activity performed on the user-operated device 150 or based on an operator of one or more of the online systems 140 causing the consumer's activity to be captured and entered into one or more of the LOB repositories 110.

In the embodiment, illustrated in the FIG. 1A, the LOB repositories 110 include for: entertainment 110A, apparel 110B, food 110C, travel 1100, hospitality 110E, finance 110F, and retail 110G.

The transaction data (purchases, social media transactions, venue ticket redemption, gaming, etc.) may be initially captured by a variety of online systems 140 or provided from online systems 140 to third-parties for management within the LOB repositories 110. In fact, some of this data within the LOB repositories 110 can be purchased by third-parties for reselling to other marketers, retailers, etc.

The aggregator 120 is one or more software modules represented as executable instructions that execute on one or more processors of one or more network devices. The integration service 130 is one or more software modules represented as executable instructions that execute on one or more processors of one or more network devices.

The integration service 130 interacts with the aggregator 120 for purposes of establishing a global cross-LOB identity for a given consumer.

During operation of the system 100, a user is presented with an interface on the user-operated device 150 requesting the user to register with the integration service 130. This entails obtaining through the interface a user identity and credentials for authenticating for access to the integration service 130. Once registered, the user has online access through the interface (such as a mobile application executing on the user device 150) for interacting with a user-facing interface of the integration service 130.

Next, the integration service 130 requests user authorization to establish a global identity for the user across multiple LOB. For each different LOB, the interface request identifying information for the user that can uniquely identify the user within a specific LOB 110. The identifying information for the user can be unique to an entire LOB or unique to specific businesses within a specific LOB.

Identifying information for the user can include things such as, but not limited to, a loyalty number for a specific business, an account number for a specific business, frequent flyer number, credit card number(s), a government issued identification number(s) (driver's license, passport number, etc.), an email address used with multiple businesses (perhaps across multiple different LOB), a phone number (or numbers) used with multiple businesses (perhaps across multiple different LOB), birth date, home address, and others.

In some cases, the user may authorize credential information for accessing a user account with specific businesses within one or more of the LOB. Here, the user can supply the login identifier for any such account along with the user's authenticating credentials. This, in some embodiments, permits the integration service 130 to log into a specific business from the online systems 140 as the user to establish a session with a specific business.

Once the appropriate authorizations are obtained from the user for user identifying information and, if desired, access to user accounts as the user through the online systems 140, the integration service 130 can interact with the aggregator 120 to perform a variety of novel and beneficial processing on behalf of the user and/or the online systems 140.

The aggregator 120 can maintain (although it does not have to as explained below) a global unique identifier for the user (unique across the LOB 110), such as an identity assigned to the user when the user signs into an authenticated session with the integration service 130.

The aggregator 120 dynamically mines on a per-request basis or on a batch basis, the LOB repositories 110 for transaction data of transactions having the user-supplied identifying information to identify specific cross-LOB transactions linked to activity of the user. Essentially, the aggregator 120 aggregates the user's different known personas for businesses across multiple LOB repositories 110 creating an aggregated or federated identity for the user linked to the global identity (identity known for the user by the integration service 130).

The transaction data can include a variety of rich data on the user, such as, and by way of example only, customer name, customer account, customer identifier, credit card used, date and time of transaction, item purchased, retailer where purchased, venue of ticket redemption, type of venue, event held at the venue, restaurant visited, food ordered, amount of transaction, product identifiers, and the like. In fact, anything that is captured electronically during a transaction can be captured. This data when natively captured may be in a retail or venue-specific format or may even be unstructured. The aggregator 120 can obtain the transaction data from the LOB repositories 110 or other sources (not shown in the FIG. 1A). That is, it is not necessary for the LOB repositories 110 to have all customer aggregated data housed in an aggregated data store, such that just those transactions for which the transaction data can be obtained (either through licensing, customer approval, retail agreements, and the like) may be aggregated as needed by the aggregator 120. Although, there is no technical impediments to having all such data in the LOB repositories 110 just legal impediments. Therefore, in some cases, the LOB repositories may include all transaction data captured for a customer across all known LOB for the customer.

The aggregator 120 interacts with the integration service 130 to provide a variety of useful features utilizing the global user identity (an aggregated identity including the linkage between unique identity for the user known to the integration service 130 and user identifying information across LOB for the user as supplied by the user). Such features (as discussed below), may also be available to employees of the online systems 140 for marketing to the user or user-segments defined for marketing.

For example, the integration service 130 can instruct the aggregator 120 to aggregate transactions for the user identifying information from the LOB repositories 110 in batch at periodic intervals. A global profile for the user that spans multiple different LOB can then be developed by the integration service 130 analyzing the data. For example, twice a week the user fills his/her gas tank at station Y and buys milk at store X and once a month eats at restaurant Z. Profiles of different global identities (different users) can be classified into similar segments for marketing (based on a scoring algorithm). These segments can be made available to the online systems 140 for marketing. In fact, the criteria for defining the profiles and segments can be defined by the online systems 140 through interfaces to the integration service 130.

When a user logs into the integration service 130, the user-facing interface can push a variety of available features to the user. Such as, “do you want to see all your transaction for retailer X;” “do you want to see all your transactions for credit card Y;” do you want to see all transaction relevant to entertainment;” etc. In response, the integration service 130 instructs the aggregator 120 to obtain the relevant transactions, which the aggregator provides back to the integration service 130 and the integration service 130 parses the results and presents a user-readable listing and/or summary back to a user interface of the user device 150 for viewing by the user. Pre-packaged features of the interface can be provided to the user through interaction of the integration service 130 and the user device 150. In addition, the user may custom-define queries that span multiple LOB activity.

Similarly, features available through the integration service 130 and the aggregator 120 can be made available to interfaces of the online systems 140. Here, the true identity of a particular user may remain anonymous to any retailer associated with the online systems 140. The retailer uses interfaces exposed by the integration service 130 to define criteria for defining customer segments and receive back (through processing of the aggregator 120 and the integration service 130) transactional data for defined customer segments for customer transaction data that spans multiple LOB.

The FIG. 1B is now discussed within the context of additional features that can be provided through the novel processing of the aggregator 120 and the integration service 130 when aggregating and integrating identities across multiple LOB.

The FIG. 1B is a diagram a sample architecture 160 for practicing identity aggregation and integration according to an example embodiment.

The architecture 160 includes a plurality LOB storage services 170, an aggregator/integrator service 180, Representational State Transfer (Restful interfaces) 189, and LOB 190.

The LOB storage services 170 include (in this sample embodiment) retail services 171, financial services 172, hospitality services 173, and travel services 174.

The aggregator/integration service 180 includes sub-processing modules and data modules that include: a global consumer identity 181, cross LOB-Authenticated tokens 182, cross-LOB identifiers 183, cross-LOB authorization 184, cross LOB preferences 185, a cross-LOB graph builder 188, and a cross-LOB transaction graph navigation/metrics enabler 186.

The LOB 190 includes systems and interfaces native to a variety of LOB, such as retail services 191, travel services 192, hospitality services 193. and financial services 194.

In the embodiment described in the architecture 160, the same features available to a user through the user device 150 are available as was discussed above with the description of the FIG. 1A. Therefore, the user device 150 although not specifically referenced in the FIG. 1B will be referenced in some of the illustrated feature processing discussed with the architecture 160. Moreover, the aggregator/integrator service 180 may be viewed as the combination of the aggregator service 120 and the integrator service 140 discussed in the FIG. 1A.

The architecture 160 includes processing for handling novel tokens issued from the aggregator/integrator service 180. These tokens 182 are appended to or capable of being acquired from any given transaction and processed in the manners discussed herein and below. It is noted that in some of the embodiments, a new and novel interface is deployed and operational on LOB Point-Of-Sale (POS) terminals for obtaining, processing, recognizing, and/or interacting with the aggregator/integrator service 180 to perform the features discussed herein with the architecture 160.

For example, a user provides authorization for cross-LOB aggregation and integration (as discussed above and through interaction with the aggregator/integrator service 180). Once this is done, when the user wants to grant cross-LOB access to an account held by that user for a second different user to access during a transaction, the processing of the architecture may proceed as follows. The authenticated first user establishes an authenticated session with the aggregator/integrator service 180 and a global consumer identity 181 is assigned to that user (based on authentication of the first user).

Interfaces exposed to the first user permits the first user o designate a second user (through some unique data known to the aggregator/integrator service, such as phone number, email, etc.) and an account of the first user to which the second user is permitted access for a subsequent transaction. The first user can also define security conditions for the subsequent transaction, such as based on specific retailer in a specific LOB 190 at a specific location and for a specific valid time period or calendar date; a specific LOB 190, etc. (in fact a variety of conditions can be set by the first user).

When the second user conducts a transaction at a POS terminal for LOB 190, the POS terminal though transaction data or a modified interface of the POS terminal obtains identity information for the second customer and using the Restful interfaces 189 communicates that to the aggregator/integrator service 180. The aggregator/integrator service 180 has already previously associated the authorization for the second user to access the first user's account based on the authorization provided by the first user by generating a cross-authenticated token 182 and assigning that token to the second user.

The aggregator/Integrator service 180 then ensures that all first user conditions are met and appends the cross LOB-authenticated token to the transaction data and provides back to the POS terminal. The POS terminal then presents through a modified interface an option for the second user to proceed with the transaction utilizing an account of the second user based on the cross-LOB authenticated token 182. Access to the first user account by the second user can include a variety of types of accounts, such as access to withdraw funds from a bank account of the first user in a predefined amount of funds, access to redeem loyalty points possessed by the first user, access to a specific promotion (such as when the first user is a retailer and the second user is defined in a customer segment by the retailer as being eligible for the specific promotion).

In addition to the above scenarios, other situations can occur as well through the novel processing of the aggregator/integrator service 180. For example, the aggregator/integrator service 180 can maintain a specific user's cross-LOB authorizations 184 and cross-LOB preferences 185. Each transaction processed by the aggregator/integrator service 180 is lagged with a cross-LOB identifier 183 (of can be obtained my mining the LOB storage services 170 in a dynamic fashion without any tagging). This permits cross-LOB access to be maintained by the user based on the user's global consumer identity 181. For example, the user may not want the user's financial LOB exposed to any user or maintained in any fashion for cross-LOB access. This also permits the user to expose the user's preferences through the cross-LOB preferences 185.

In another case, the user and/or a retailer may obtain metrics associated with the user or a custom-defined segment of users based on cross LOB transactional data. For example, suppose a user wants to see all transactions based on each separate line of business by accessing a user interface exposed by the aggregator/integrator service 180, the user makes the request. The aggregator/integrator service 180 obtains the transactional data (as discussed above using the user identifying information. The cross-LOB transaction graph builder 188 summarizes the transactional data into graph data. The cross-LOB transaction graph navigation/metrics enabler presents the graph to the user interface and permits the user to interact with the displayed graph to obtain specific metrics. It is noted that this feature can also be used by a user that is a retailer through the restful APIs 189.

It is now appreciated how the aggregator/integrator service 180 aggregates and integrates user personas into a global consumer identity. This can be used for novel transaction processing, novel metrics gathering, novel reporting, and novel marketing that spans multiple LOB.

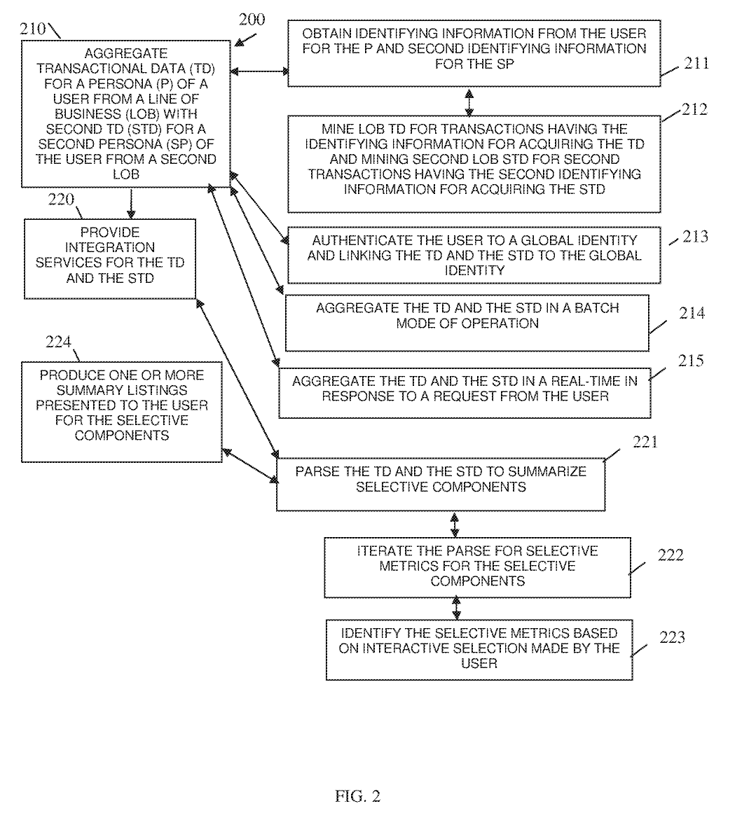

These and other embodiments are no discussed with reference to the FIGS. 2-4.

FIG. 2 is a diagram of a method 200 for identity aggregation and integration, according to an example embodiment. The software module(s) that implements the method 300 is referred to as an “identity aggregator and integration manager.” The identity aggregator and integration manager is implemented as executable instructions programmed and residing within memory and/or a non-transitory computer-readable (processor-readable) storage medium and executed by one or more hardware processors of a hardware computing device. The processors of the device that executes the identity aggregator and integration manager are specifically configured and programmed to process the identity aggregator and integration manager. The identity aggregator and integration manager has access to one or more networks during its processing. The networks can be wired, wireless, or a combination of wired and wireless.

In an embodiment, the device that executes the identity aggregator and integration manager is a server.

In an embodiment, the device that executes the identity aggregator and integration manager is a cloud processing environment having a variety of hardware devices logically organized as a single processing environment.

In an embodiment, the identity aggregator and integration manager is the aggregator service 120 and the integration service 130.

In an embodiment, the identity aggregator and integration manager is the aggregator/integrator 180.

At 210, the identity aggregator and integration manager aggregates transactional data for a persona of a user from a LOB with second transaction data for a second persona of the user from a second LOB. The transaction data can include anything defined above with respect to the FIG. 1A. A persona is a unique identifier for the user within a particular LOB or for a particular business within a particular LOB. The unique identifier can include any of the identifying information discussed above or combinations of identifying information discussed above with the FIGS. 1A and 1B.

In an embodiment, at 211, the identity aggregator and integration manager obtains identifying information from the user for the persona and second identifying information for the second persona. This can be done in the manners and using the interfaces discussed above with the FIGS. 1A and 1B.

In an embodiment of 211 and at 212, the identity aggregator and integration manager mines LOB transactional data having the identifying information for acquiring the transactional data, and the identity aggregator and integration manager mines a second LOB transactional data having the second identifying information for acquiring the second transactional data.

In an embodiment, at 213, the identity aggregator and integration manager authenticates the user to a global identity and links the transactional data and the second transactional data to the global identity. This can be done by the user authenticating to the identity aggregator and integration manager and assigning that user the global identity (maintained by the identity aggregator and integration manager). In some cases, this may be done by the user authenticating over a first LOB and the identity aggregator and integration manager receiving notice of such authentication (such as through a retail online system 140 or a POS terminal of the online system 140) and noting that the user has authorized user authentication for transacting over a second LOB and associating a cross-LOB authenticated token 182 with the user's global identity based on user authentication of the first LOB).

In an embodiment, at 214, the identity aggregator and integration manager aggregates the transactional data and the second transactional data in a batch mode of operation. This may be useful for retailer access and/or based on user-defined periodic reporting of cross-LOB user activity.

In an embodiment, at 215, the identity aggregator and integration manager aggregates the transactional data and the second transactional data in real time in response to a request from the user.

It is to be noted that the processing at 214 and 215 is not mutually exclusive, such that the identity aggregator and integration manager can do both batch and real-time aggregation depending upon selected modes of operation or configurations for the identity aggregator and integration manager.

At 220, the identity aggregator and integration manager provides integration services for the aggregated transaction data and second transaction data. Any of the services or features discussed above with the FIGS. 1A and 1B can be provided by the identity aggregator and integration manager.

In an embodiment, at 221, the identity aggregator and integration manager parses the transaction data and the second transaction data to summarize selective components of the aggregated data.

In an embodiment of 221 and at 222, the identity aggregator and integration manager iterates the processing at 221 for producing selective metrics for the selective components.

In an embodiment of 222 and at 223, the identity aggregator and integration manager identifies the selective metrics based on interactive selection made by the user (such as through the interfaces discussed above with the FIGS. 1A and 1B).

In embodiment of 221 and at 224, the identity aggregator and integration manager produces one or more summary listed presented to the user for the selective components.

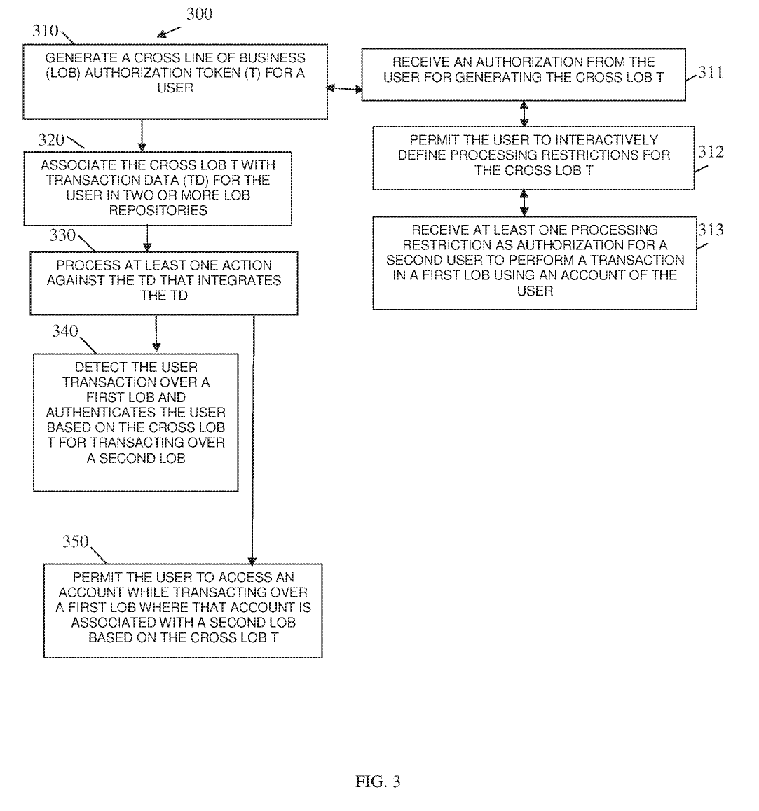

FIG. 3 is a diagram of another method 300 for identity aggregation and integration, according to an example embodiment. The software module(s) that implements the method 300 is referred to as an “aggregator/integrator service.” The aggregator/integrator service is implemented as executable instructions programmed and residing within memory and/or a non-transitory computer-readable (processor-readable) storage medium and executed by one or more hardware processors of a hardware device. The processors of the device that executes the aggregator/integrator service are specifically configured and programmed to process the aggregator/integrator service. The aggregator/integrator service has access to one or more networks during its processing. The networks can be wired, wireless, or a combination of wired and wireless.

In an embodiment, the device that executes the aggregator/integrator service is a server.

In an embodiment, the device that executes the aggregator/integrator service is a proxy to an online system 140.

In an embodiment, the device that executes the aggregator/integrator service is a cloud processing environment.

In an embodiment, the aggregator/integrator service is the aggregator service 120 and the integration service 130.

In an embodiment, the aggregator/integrator service is the aggregator/integrator 180.

In an embodiment, the aggregator/integrator service is the method 200 of the FIG. 2.

In an embodiment, the aggregator/integrator service is some combination of the aggregator service 120, the integration service 130, the aggregator/integrator 180, and the method 200 of the FIG. 2.

At 310, the aggregator/integrator service generates a cross LOB authorization token.

In an embodiment, at 311, the aggregator/integrator service receives an authorization from the user for generating the cross LOB authorization token.

In an embodiment of 311 and at 312, the aggregator/integrator service permits the user to interactively define processing restrictions for the cross LOB authorization token.

In an embodiment of 312 and at 313, the aggregator/integrator service receives at least one processing restriction as authorization for a second user to perform a transaction in a first LOB using an account of the user.

At 320, the aggregator/integrator service associates the cross LOB authorization token with transaction data for the user in two or more LOB repositories.

At 330, the aggregator/integrator service processes at least one action against the transaction data that integrates the transaction data across the two or more LOB.

According to an embodiment, at 340, the aggregator/integrator service detects the user transacting over a first LOB and authenticates the user based on cross LOB authorization token for transacting over a second LOB.

In an embodiment, at 350, the aggregator/integrator service permits the user to access an account while transacting over a first LOB where that account is associated with a second LOB based on the cross LOB authorization token.

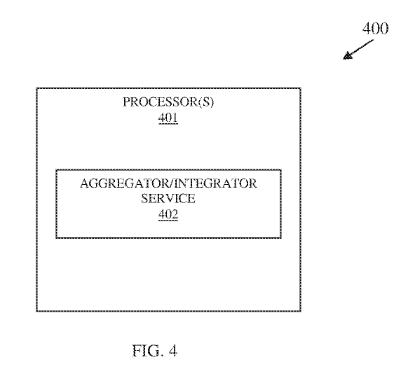

FIG. 4 is a diagram of a system 400 for identity aggregation and integration, according to an example embodiment. The system 400 includes a variety of hardware components and software components. The software components of the system 400 are programmed and reside within memory and/or a non-transitory computer-readable medium and execute on one or more hardware processors of a hardware device. The system 400 communicates one or more networks, which can be wired, wireless, or a combination of wired and wireless.

In an embodiment, the system 400 implements all, any, or some combination of the processing discussed above with the FIGS. 1A-1B and 2-3.

The system 400 includes at least one hardware processor 401 and an aggregator/integration service 402.

In an embodiment, the hardware processor 401 is part of a server.

In an embodiment, the hardware processor 401 is part of a proxy for an online system 140.

In an embodiment, the hardware processor is part of a cloud processing environment.

The aggregator/integration service 402 is configured to: execute on the processor 401, aggregate transactional data for a user occurring over multiple different LOB, and provide services for integrating the aggregated transactional data.

In an embodiment, the aggregator/integration service 402 is further configured to associate user-provided authentication tokens to transactions over the multiple LOB.

In an embodiment of the preceding embodiment, the aggregator/integration service 402 is further configured to provide the services for one or more of: custom reporting for the aggregated transactional data, custom metrics generation for the aggregated transactional data, and transact over the multiple LOB.

In an embodiment, aggregator/integration service 402 is the aggregation service 120 and the integration service 130.

In an embodiment, the aggregator/integration service 402 is the aggregator/integrator service 180.

In an embodiment, the aggregator/integration service 402 is the method 200 of the FIG. 2.

In an embodiment, the aggregator/integration service 402 is the method 300 of the FIG. 3.

In an embodiment, the aggregator/integration service 402 is deployed as a Software as a Service (SaaS) over a network.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
aggregating transactional data for a persona of a user from a line of business (LOB) with second transactional data for a second persona of the user from a second LOB: and
providing integration services for the transaction data and the second transaction data.

2. The method of claim 1, wherein aggregating further includes obtaining authorization from the user for aggregating the first LOB and the second LOB.

3. The method of claim 1, wherein aggregating further includes obtaining identifying information from the user for the persona and second identifying information for the second persona.

4. The method of claim 3, wherein obtaining further includes mining LOB transactional data for transactions having the identifying information for acquiring the transactional data and mining second LOB transactional data for second transactions having the second identifying information for acquiring the second transactional data.

5. The method of claim 1, wherein aggregating further includes authenticating the user to a global identity and linking the transactional data and the second transactional data to the global identity.

6. The method of claim 1, wherein aggregating further includes aggregating the transactional data and the second transactional data in a batch mode of operation.

7. The method of claim 1, wherein aggregating further includes aggregating the transactional data and the second transactional data in a real-time in response to a request from the user.

8. The method of claim 1, wherein providing further includes parsing the transactional data and the second transactional data to summarize selective components.

9. The method of claim 8, wherein providing further includes iterating the parsing for selective metrics for the selective components.

10. The method of claim 9, wherein iterating further includes identifying the selective metrics based on interactive selection made by the user.

11. The method of claim 8, wherein providing further includes producing one or more summary listings presented to the user for the selective components.

12. A method, comprising:
generating a cross line of business (LOB) authorization token for a user;
associating the cross LOB authorization token with transaction data for the user in two or more LOB repositories; and
processing at least one action against the transaction data that integrates the transaction data.

13. The method of claim 12, wherein generating further includes receiving an authorization from the user for generating the cross LOB authorization token.

14. The method of claim 13, wherein receiving further includes permitting the user to interactively define processing restrictions for the cross LOB authorization token.

15. The method of claim 14, wherein permitting further includes receiving at least one processing restriction as authorization for a second user to perform a transaction in a first LOB using an account of the user.

16. The method of claim 12 further comprising, detecting the user transaction over a first LOB and authenticating the user based on the cross LOB authorization token for transacting over a second LOB.

17. The method of claim 12 further comprising, permitting the user to access an account while transacting over a first LOB where that account is associated with a second LOB based on the cross LOB authorization token.

18. A system, comprising:
a hardware processor;
an aggregator/integrator service configured to: (i) execute on the hardware processor; (ii) aggregate transactional data for a user occurring over multiple different lines of business (LOB), ii) provide services for integrating the aggregated transactional data.

19. The system of claim 18, wherein the aggregator/integrator service is configured to: iv) associate user-provided authentication tokens to transactions over the multiple LOB.

20. The system of claim 19, the aggregator/integrator service is configured, in iii), to: provide the services for one or more of: custom reporting for the aggregated transactional data, custom metrics generation for the aggregated transactional data, and transact over the multiple LOB.
